(19) United States
(12) Patent Application Publication
(10) Pub. No.: US 2022/0034813 A1
(43) Pub. Date: Feb. 3, 2022

(54) OPTICAL ARRANGMENT FOR FLUORESCENCE MICROSCOPY APPLICATIONS

(71) Applicants: FRAUNHOFER-GESELLSCHAFT ZUR FÖRDERUNG DER ANGEWANDTEN FORSCHUNG E.V., München (DE); Friedrich-Schiller-Universitaet Jena, Jena (DE)

(72) Inventors: Markus GRAEFE, Jena (DE); Marta GILABERTE BASSET, Jena (DE); Falk EILENBERGER, Jena (DE); Frank SETZPFAND, Jena (DE)

(73) Assignees: Fraunhofer-Gesellschaft Zur Foerderung Angewandten Forschung E.V., Muenchen (DE); Friedrich-Schiller-Universitaet Jena, Jena (DE)

(21) Appl. No.: 17/275,705

(22) PCT Filed: Sep. 12, 2019
(86) PCT No.: PCT/EP2019/074340

§ 371 Date: Mar. 12, 2021

(30) Foreign Application Priority Data
Sep. 18, 2018 (DE) 10 2018 215 833.9

(51) Int. Cl. G01N 21/64; G02B 21/16; G02B 21/06

(52) U.S. Cl. CPC G01N 21/6458; G02B 21/06; G02B 21/16

(57) ABSTRACT

In the optical arrangement for fluorescent microscopic applications, one or more multiphoton beams, but at least one or two photon pair beams, from a source of non-classical light is/are directed at a first optical system, consisting of an arrangement of at least one lens or one photon-reflecting element or another beam-forming element or a combination thereof. The first optical system (3) is designed to shape the non-classical light into a light sheet (4) or a light sheet-like shape and thence to direct it at a specimen (5), so that fluorescent radiation is excited by means of multiphoton absorption using the multiple multiphoton beams that are simultaneously incident on/in the specimen. Fluorescent radiation (6) obtained by excitation is incident by means of a second optical system (7) on a detection system (8) that is designed for the spatially resolved capture of fluorescent radiation.

### BACKGROUND OF THE INVENTION

The invention relates to an optical arrangement for fluorescence microscopy applications using non-classical light. The field of application is fluorescence microscopy and multiphoton absorption analysis. This is of great importance, for example, for the microscopic examination of bio-chemical samples in the life sciences and medicine, but also for chemical/material analysis investigations of substances.

The excitation and detection of fluorescent light is carried out by means of multiphoton, in particular two-photon absorption of photon pairs for applications that can be carried out analogously to fluorescence microscopy.

There are already various approaches to solving this problem, but they all have fundamental disadvantages. In principle, these known solutions can be divided into three categories:

a. Two-photon fluorescence microscopy using classical light as disclosed in U.S. Pat. Nos. 5,503,613 B and 6,020,591 B. Two-photon absorption is realized by means of continuous wave lasers with very high intensity or by pulsed lasers with pulses in the picosecond or femtosecond range. The two-photon absorption probability and thus also the fluorescence intensity depend quadratically on the instantaneous excitation intensity. The exciting laser radiation is focused to improve the absorption probability. In classical two-photon fluorescence microscopy, the focus is formed axially along the optical axis of the system. The fluorescent molecules can only be excited by two-photon absorption and thus show fluorescence when they are focused. However, the entire sample area along the optical axis is exposed to a high radiation dose and correspondingly high energy. This leads to both fluorescence bleaching and phototoxicity, especially in biological samples.

b. An alternative solution is the two-photon light sheet mode. Here, the focus of the excitation radiation is formed as a plane—called a light sheet—perpendicular to the direction of observation. For this purpose, the sample to be examined is laterally illuminated by a suitable optical system. The light sheet can be formed by a line focus, line image, or a laterally scanning laser beam. Only in this light sheet can fluorescent molecules be excited by two-photon absorption and thus show fluorescence. The disadvantage of this method is the necessity of illumination with very high intensity continuous wave lasers or laser systems for ultra-short laser pulses. In both cases, the sample is irradiated with high intensity laser radiation or even laser pulses and exposed to a high dose of irradiation with high energy. This leads to both fluorescence bleaching and phototoxicity, especially in biological samples. Here, too, the two-photon absorption probability and thus also the fluorescence intensity depend quadratically on the instantaneous excitation intensity.

c. Photon pair fluorescence microscopy possibilities are also known from U.S. Pat. No. 5,796,477 B. Here, two-photon absorption is not excited by high-intensity or pulsed lasers, but by photon pairs consisting of two correlated (in space, time, momentum and/or energy) photons. In particular, these can be generated by spontaneous differential frequency conversion in a nonlinear crystal outside the sample. The two photons can be spatially separated from each other as they move from the photon pair source to the respective sample. If they have a different wavelength, this can be achieved with a dichroic mirror. If they have opposite polarization, they can be spatially separated by a polarization beam splitter. However, it is equally possible that both photons leave a crystal with nonlinear optical properties in a spatially separated manner and are thus already spatially separated. The two photon beams are then focused into the sample in a crossed manner. In the overlap region of the photons meeting at the focus, two-photon absorption can then take place. In this scenario, the two-photon absorption and thus the fluorescence intensity are linearly proportional to the instantaneous excitation intensity. Another advantage is that the focal volume can be smaller compared to the method described under a. The disadvantage of this method is the complex experimental setup, since it must be ensured that both photons of a pair arrive in the beam overlap volume at exactly the same time and collide within the sample. This may be complicated by the very short coherence time and possibly different but correlated wavelength of the two photons. Therefore, a very precise adjustment, at the expense of flexibility and practicality, is required.

### SUMMARY OF THE INVENTION

It is therefore the object of the invention to provide possibilities for fluorescence microscopy with which the local energy input during fluorescence excitation can be reduced and with which a simple optical setup with reduced adjustment effort can be used.

According to the invention, this object is achieved with an optical arrangement having the features of the claims.

The method proposed here is based on the use of a preferably collinear source from which, in particular, photon pairs or also multiphoton states are emitted simultaneously onto a sample and the principle of light sheet microscopy is applicable.

A source of non-classical light emits multiphoton beams, but at least photon pair beams of in particular photon pairs or but also multiphoton states, preferably in collinear geometry. This can be achieved by spontaneous differential frequency conversion/spontaneous parametric fluorescence in a nonlinear and periodically poled optical crystal. The multiphoton beam(s) passes through a first optical system onto a sample so that a light sheet or light sheet-like shape is formed.

The light sheet or the light sheet-like shape can be formed as a temporally constant line focus but also as a photon beam scanned in the light sheet plane or composed by the temporal sequence of small partial light sheets. A suitable first optical system may be a lens or a photon reflecting optical element or a polarizing optic or an optical filter or any arrangement of more than one of these optical elements.

A light sheet or light sheet-like shape can also be achieved by moving an optical element, which may be part of the first optical system. For example, a photon-reflecting element can be pivoted about an axis of rotation, thus changing the position on the sample where the photon pairs impinge simultaneously, similar to what is possible with the well-known scanner mirrors in laser technology.

Only in the area of the formed light sheet or the area of the sample that is transilluminated by the light sheet-like form is simultaneous absorption of several photons, in particular of photon pairs, and thus fluorescence excitation possible. A part of the fluorescence radiation will impinge on a detection system with optional use of a second optical system and will be detected there. The second optical system may be an optical lens, or a fluorescent radiation reflecting element, or a polarizing optic, or an optical filter, or any arrangement of more than one of these optical elements. A detector system should render possible spatially resolved measurement of the fluorescence radiation excited within the light sheet. The detector system can be a camera with sufficient sensitivity. Examples are a CCD, EMCCD, ICCD, CMOS camera, SPAD array. It may include an optical filter or a second optical system. The second optical system and the detection system can also be designed as a unit.

In another embodiment of the invention, multiple photon beams can also be used so that fluorescence can be excited simultaneously in multiple light sheets or in regions having a light sheet-like shape on the sample. The excitation of fluorescence can also be done explicitly via multiphoton absorption of multiphoton states, especially pairs of photons impinging simultaneously on a sample. Such multiphoton states can be realized e.g. by so-called NOON states, in which case N-photon absorption takes place.

A source of nonclassical light may be, for example, a laser-pumped nonlinear crystal or another source of photon pairs or multi-photon states, such as a laser-pumped waveguide structure in a nonlinear crystal, or at least two identical coherently pumped quantum dots.

The solution according to the invention has several advantages over the prior art for fluorescence microscopy using multiphoton absorption. Since the fluorescence intensity scales linearly with the instantaneous illumination intensity, the irradiation dose of the sample can be reduced while maintaining the signal yield, or the signal strength and image contrast of the fluorescence radiation detected by the detection system can be increased while maintaining the irradiation dose. The method is thus maximally gentle, without unnecessary light exposure of the sample, and thus allows long-term studies of photosensitive samples, as both fluorescence bleaching and phototoxicity can be minimized. In contrast to photon pair fluorescence microscopy, the setup is significantly simplified and more robust, so that a cost reduction and improvement of the axial resolution can be achieved. The collinear setup is compatible and implementable with existing light sheet microscope systems. In addition, multi photon radiation with photons of a certain center wavelength can be focused to focal volumes which otherwise can only be reached with laser light of half the wavelength. This can increase the axial resolution of the detectable fluorescence radiation within the particular light sheet. Overall, increased efficiency, increased spatial resolution and increased penetration depth are possible. Likewise, the linear relationship between fluorescence intensity and photon beam intensity is advantageous for data evaluation, since there is a linear relationship between the measurand (fluorescence signal) and the excitation quantity (radiation dose).

### DESCRIPTION OF THE FIGURE

In the following, the invention will be explained in more detail by way of an example.

In the drawings:

FIG. 1 schematically shows an example of an arrangement according to the invention.

FIG. 1 shows how a photon pair beam 2 from a collinear source of non-classical light 1 is directed towards a first optical system 3. The first optical system 3 may be configured as defined in the claims.

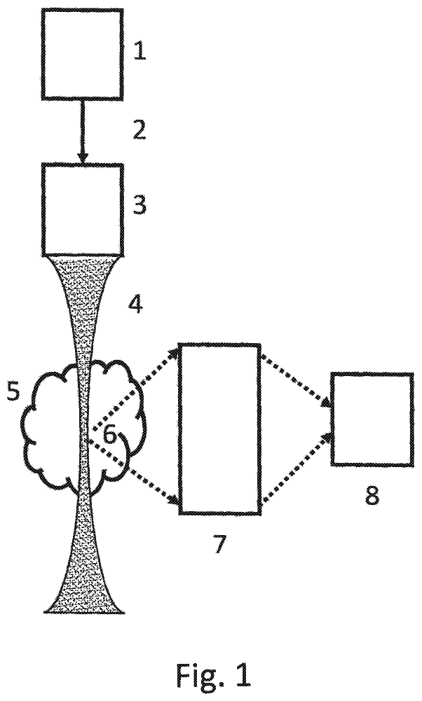

The photon pair beam 2 influenced by the first optical system 3 is directed onto/into the sample 5 in such a way that at least one-dimensional linear movement of the position at which the photon pair beam 2 impinges on the sample 5 or enters the sample occurs to form a light sheet 4. The movement can be achieved by a movement of an element reflecting the photons, in particular by means of a pivoting movement about a rotation axis of a reflecting element.

With photon pairs impinging on the sample 5 or entering the sample 5, excitation of fluorescent radiation 6 within the light sheet 4 is achieved.

The fluorescent radiation 6 thus generated is incident on a second optical system 7, which is also configured as defined in the claims. The detector system 8 is used for spatially resolved detection of fluorescence radiation, which can be evaluated by fluorescence microscopy.

1. Optical arrangement for fluorescence microscopy applications, in which from a source of non-classical light one or more multiphoton beam(s), but at least one or two photon pair beam(s) is/are directed onto a first optical system consisting of an arrangement of at least one lens or photon reflecting element or other beam shaping element or a combination thereof,
the first optical system is adapted to form the non-classical light into a light sheet or a light sheet-like shape,
directed to a sample such that fluorescence radiation is excited with several multiphoton beams incident simultaneously on/in the sample by means of multiphoton absorption, and
fluorescence radiation obtained by excitation occurs, by means of a second optical system, on a detection system which is designed for spatially resolved detection of fluorescence radiation.

2. The arrangement according to claim 1, wherein the source of nonclassical light is a nonlinear crystal pumped by a laser or waveguide structure in a nonlinear crystal, or at least two identical coherently pumped quantum dots.

3. The arrangement according to claim 1, wherein the one or more multiphoton beam(s), but at least the one or more photon pair beam(s), is/are directed, in collinear geometry, towards the first optical system.

4. The arrangement according to claim 1, wherein the fluorescence radiation can be excited with two photons in the form of a photon pair.

5. The arrangement according to claim 1, wherein the formation of the light sheet is performed by means of the first optical system, which is adapted to linearly change at least one multiphoton beam the position of impingement of the at least one multiphoton beam on/in the sample by a movement of an optical element which is part of the first optical system, so that a corresponding line-shaped region of at least one line is irradiated at least once.

6. The arrangement according to claim 1, wherein a multiphoton beam emitted by a photon beam source is split into a plurality of partial beams and the partial beams are directed onto/into the sample by means of the first optical system for forming a respective light sheet.

7. The arrangement according to claim 1, wherein the formation of at least one light sheet or light sheet-like shape is effected by means of the first optical system which is designed to linearly change a position of impingement of the partial beams on/in the sample by a movement of at least one optical element which is a component of the first optical system, so that a corresponding line-shaped region of at least one line is irradiated at least once with a partial beam.

8. The arrangement according to claim 1, wherein a one- or two- or three-dimensional movement of the sample is performed for spatially resolved imaging of the sample.

9. The arrangement according to claim 1, wherein the first optical system or the second optical system is formed including a nonlinear optical crystal, an optical lens, a photon reflecting element, a polarization optics, an optical filter or an arrangement of a plurality of these optical elements.

10. An arrangement according to claim 1, wherein the multiphoton beam emitted collinearly by the source of non-classical light is divisible by means of a dichroic mirror or a polarization beam splitter into a plurality of partial beams directed at/into the sample at different positions.

11. The arrangement according to claim 1, wherein the detector system is a CCD, an EMCCD, an ICCD or a CMOS camera or a SPAD array.
